(19) United States
(12) Patent Application Publication
(10) Pub. No.: US 2026/0095495 A1
(43) Pub. Date: Apr. 2, 2026

(54) Selectively Prioritizing Video Stream Traffic Using A Predicted Buffer Health In A Satellite Network

(71) Applicant: Hughes Network Systems, LLC, Germantown, MD (US)

(72) Inventors: Edward BEAL, Germantown, MD (US); Venkatasubramaniam GANESAN, Germantown, MD (US)

(73) Assignee: Hughes Network Systems, LLC, Germantown, MD (US)

(21) Appl. No.: 18/898,916

(22) Filed: Sep. 27, 2024

(51) Int. Cl. H04L 65/752; H04L 65/80

(52) U.S. Cl. CPC H04L 65/752; H04L 65/80

(57) ABSTRACT

A method and system for selectively prioritizing data packets of video streaming traffic in a playback buffer are disclosed. The method involves predicting the buffer health of a video player by analyzing metrics of the video streaming traffic and prioritizing the video streaming traffic based on the health of the buffer. The system includes a processor and memory with instructions to perform these functions. Additional features include prioritizing bandwidth using configured values, handling prioritization requests for both normal and low buffer health conditions, and canceling the prioritization based on network load. This innovative approach ensures efficient video streaming by proactively managing the data packet prioritization process based on the predicted buffer health status of the video player.

### FIELD

The present teachings enhance video streaming quality in satellite networks by reducing rebuffering events and maintaining video quality through intelligent bandwidth prioritization.

### BACKGROUND

Video streaming has become an integral part of modern digital consumption, with millions of users accessing content on platforms like YouTube, Netflix, and other streaming services. The demand for high-quality video streaming has led to significant challenges in network management, particularly in satellite networks where bandwidth is a limited and valuable resource. Satellite networks are often used in remote or underserved areas where traditional broadband infrastructure is not feasible, making efficient bandwidth management crucial for providing a satisfactory user experience.

One of the primary challenges in video streaming over satellite networks is the latency and variability in network performance. Compared to terrestrial networks, satellite networks have higher latency due to the long distances that signals must travel. This can lead to rebuffering events, which degrade the user experience. Additionally, the dynamic nature of network load and the varying requirements of different video streaming services add complexity to bandwidth allocation. Effective management of these factors is essential to ensure smooth and uninterrupted video playback, necessitating innovative solutions to strategically prioritize video streaming traffic without starving non-video streaming bandwidth usage. The innovations include allocating prioritized bandwidth for sending segment requests and segment responses of a video player.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In some aspects, the techniques described herein relate to a method for selectively prioritizing data packets of video streaming traffic, the method including: predicting, at a terminal or a gateway, a predicted buffer health of a playback buffer by analyzing metrics of the video streaming traffic; and triggering a prioritization request to fill the playback buffer wherein the prioritization request includes a maintenance prioritization when the predicted buffer health of the playback buffer is greater than low, wherein the playback buffer is disposed on a device distinct from the gateway or the terminal.

In some aspects, the techniques described herein relate to a method, wherein the video streaming traffic includes Internet Protocol packets and the predicting includes analyzing metrics associated with the Internet Protocol packets using a deep packet inspector.

In some aspects, the techniques described herein relate to a method, further including canceling the triggering when a current network load is greater than a network load threshold.

In some aspects, the techniques described herein relate to a method, wherein the video streaming traffic is associated with a video streaming service and the predicted buffer health is determined to be low based on threshold values associated with the video streaming service.

In some aspects, the techniques described herein relate to a method, wherein the predicted buffer health is based on bandwidth prioritization values configured separately for combinations of a route, a route type, a route load threshold, and a video streaming service, and the route type includes one or more of an inroute or an outroute.

In some aspects, the techniques described herein relate to a method, wherein the triggering includes allocating a count of bits on an inroute from the terminal to the gateway with a periodicity and the count is greater than 1.

In some aspects, the techniques described herein relate to a method, wherein at least one of the count of bits on the inroute is allocated with a priority greater than normal.

In some aspects, the techniques described herein relate to a method, wherein the triggering includes allocating a count of bits on an outroute from the gateway to the terminal with a periodicity, and wherein the count is greater than 1.

In some aspects, the techniques described herein relate to a method, wherein the prioritization request includes a recovery prioritization and wherein at least one of the count of bits is allocated with a priority greater than normal.

In some aspects, the techniques described herein relate to a method, wherein the prioritization request includes a maintenance prioritization for a normal operation of filling the playback buffer and a recovery prioritization when the predicted buffer health of the playback buffer is less than or equal to low.

In some aspects, the techniques described herein relate to a method, wherein the recovery prioritization is limited in occurrences per terminal and limited in occurrences network-wide based on a current network load within a defined period.

In some aspects, the techniques described herein relate to a system to selectively prioritize data packets of video streaming traffic of a playback buffer, the system including: a processor; and a memory storing instructions that, when executed by the processor, cause the system to: predict, at a terminal or a gateway, a predicted buffer health of a playback buffer by analyzing metrics of the video streaming traffic; and trigger a prioritization request to fill the playback buffer wherein the prioritization request includes a maintenance prioritization when the predicted buffer health of the playback buffer is greater than low, wherein the playback buffer is disposed on a device distinct from the gateway or the terminal.

In some aspects, the techniques described herein relate to a system, wherein the video streaming traffic includes Internet Protocol packets and the instructions analyze metrics associated with the Internet Protocol packets using a deep packet inspector.

In some aspects, the techniques described herein relate to a system, wherein the video streaming traffic is associated with a video streaming service and the predicted buffer health is determined to be low based on threshold values associated with the video streaming service.

In some aspects, the techniques described herein relate to a system, wherein the predicted buffer health is based on bandwidth prioritization values configured separately for combinations of a route, a route type, a route load threshold, and a video streaming service, and the route type includes one or more of an inroute or an outroute.

In some aspects, the techniques described herein relate to a system, wherein the instructions allocate a count of bits on an inroute from the terminal to the gateway with a periodicity and the count is greater than 1.

In some aspects, the techniques described herein relate to a system, wherein the instructions allocate a count of bits on an outroute from the gateway to the terminal with a periodicity, and wherein the count is greater than 1.

In some aspects, the techniques described herein relate to a system, wherein the prioritization request includes a maintenance prioritization for a normal operation of filling the playback buffer and a recovery prioritization when the predicted buffer health of the playback buffer is less than or equal to low.

In some aspects, the techniques described herein relate to a system, wherein the recovery prioritization is limited in occurrences per terminal and limited in occurrences network-wide based on a current network load within a defined period.

In some aspects, the techniques described herein relate to a non-transitory processor-readable storage medium having stored therein program code of one or more software programs for selectively prioritizing data packets of video streaming traffic, wherein the program code when executed by at least one processing device causes the at least one processing device to perform: predicting, at a terminal or a gateway, a predicted buffer health of a playback buffer by analyzing metrics of the video streaming traffic; and triggering a prioritization request to fill the playback buffer wherein the prioritization request includes a maintenance prioritization when the predicted buffer health of the playback buffer is greater than low, wherein the playback buffer is disposed on a device distinct from the gateway or the terminal.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 illustrates a video prioritization system, according to various embodiments.

FIG. 2 illustrates an exemplary video streaming process when communicating via a TDMA satellite network.

FIG. 3 is a flowchart of an example method for selectively prioritizing data packets of video streaming traffic according to various embodiments.

FIG. 4A illustrates exemplary bandwidth prioritization values for an inroute for a specific video streaming service.

FIG. 4B illustrates exemplary bandwidth prioritization values for an outroute for a specific video streaming service.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

### Introduction

Video streaming is a predominant form of traffic on the contemporary Internet. However, issues concerning the quality of experience, such as rebuffering events and subpar video quality, significantly contribute to user dissatisfaction.

The rebuffering events and subpar video quality may be caused by fluctuations in network bandwidth or when the network bandwidth is low. A playback buffer stores incoming packets briefly to account for variations in network performance. This can help real-time applications like a video player deal with dynamic network performance better by storing packets and playing them out at a steady rate. For example, the playback buffer of a video player can store video segments for a few seconds to smoothly playback a video. This can help organize video segments affected by transmission issues. A rebuffering event is caused when a playback buffer is empty, i.e., all the received video segments have already been played and the player is waiting on additional segments.

The present teachings enhance video quality by diminishing a frequency and severity of rebuffering events through a prioritization of bandwidth allocated to video streaming traffic. The prioritization occurs both on the satellite forward and return channels. In some embodiments, the prioritization depends upon a predicted buffer health of the video player and a current network load.

For example, when the buffer health of a user device's video player is critically low and the network is underutilized, a substantial amount of extra bandwidth may be provisioned to the terminal without adversely affecting the available bandwidth for other terminals. Conversely, when a user device's video buffer health is satisfactory and the network is congested, the allocation of extra priority bandwidth may be limited to mitigate the additional load on the network.

The present teachings may be extended to communication networks utilizing gateway hardware and software elements for data transportation. For instance, it could be integrated into satellite communication systems or broadband services operating within communication networks employing gateway hardware and software elements similar to a satellite communications network.

### Adaptive Bitrate Streaming

Adaptive bitrate (ABR) streaming is a widely used technique by video providers such as YouTube and Netflix to deliver video content to users. ABR encodes a video file at multiple qualities, each with different bitrates. For instance, a video encoded at standard definition 360p with 30 frames per second might have a bitrate of 1 Mbps, while the same video encoded at high definition 720p with 60 frames per second might have a bitrate of 10 Mbps.

Typically, a video client (e.g., web browser, smart TV) requests and downloads video file data from a video server in small segments. Rather than downloading the entire video file in one go, the server divides it into smaller segments, often just a few seconds in length. The client then requests and downloads these segments from the server, storing them locally in a buffer for future playback. Maintaining an adequately filled playback buffer is crucial for minimizing rebuffering events.

While ABR algorithms aim to prevent rebuffering events by selecting a video bitrate that the network can sustain, the dynamic nature of networks can lead to variations in sustainable throughput over time. Additionally, ABR algorithms must balance the competing goals of minimizing rebuffering events and maximizing the quality of the video stream, the latter requiring higher throughputs. As a result, despite the efforts of ABR algorithms, rebuffering events may still occur.

### Video Prioritization System

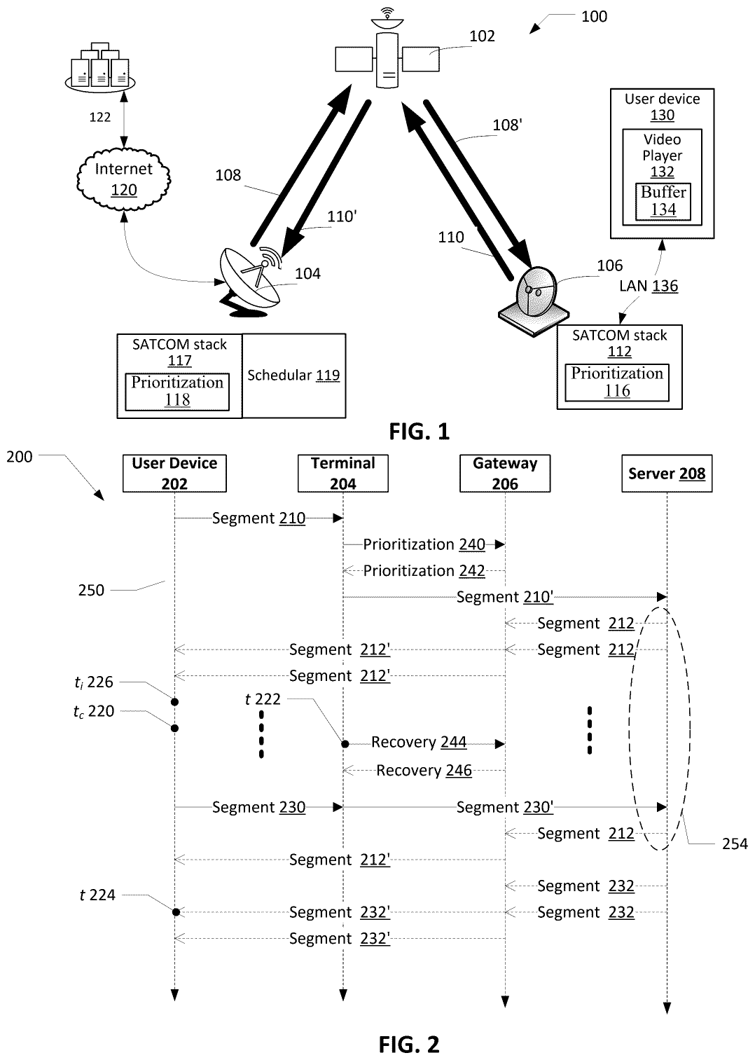

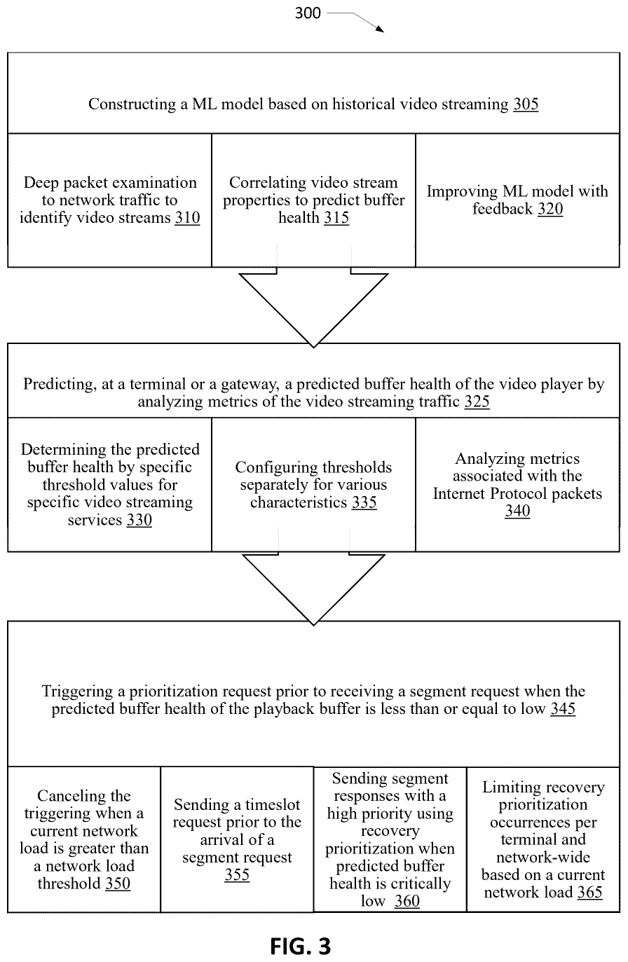

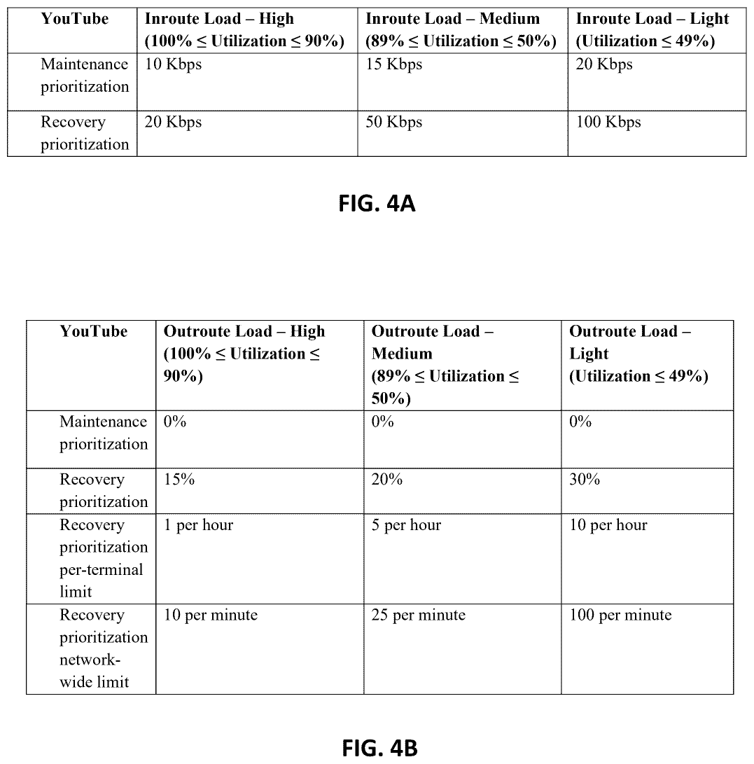

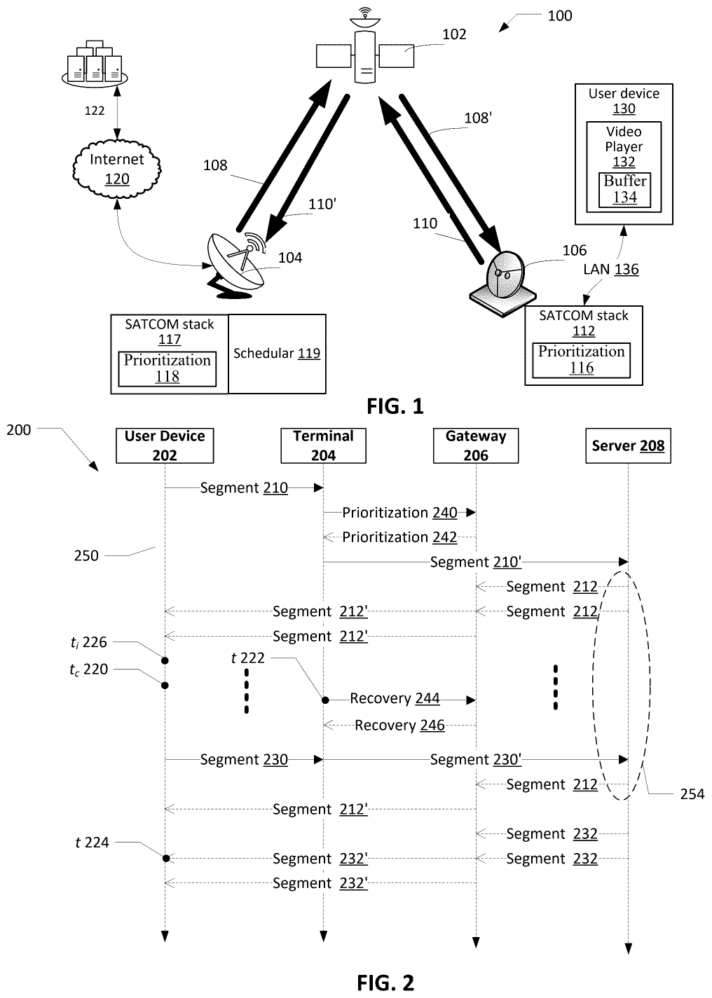

FIG. 1 illustrates a video prioritization system, according to various embodiments.

A Video prioritization system 100 uses Time Division Multiple Access (TDMA) on a frequency channel between a gateway 104 and terminal 106. TDMA is a digital modulation technique that allows a terminal population to share the same frequency channel by dividing the signal into different timeslots that may be further divided into symbols and bits using a schedular 119.

Communication from the gateway 104 to the terminal 106 is via an outroute that includes an uplink 108 from the gateway 104 to satellite 102. Satellite relays communications as a downlink 108′ to the terminal 106. Communication from the terminal 106 to the gateway 104 is via an inroute that includes an uplink 110 from the terminal 106 relayed by the satellite 102 as a downlink 110′ to the gateway 104. Gateway 104 may be terrestrially connected to internet 120 where server 122 resides.

User device 130 may host a video player 132 including a buffer 134. User device 130 connects to server 122 via the LAN 136 to the terminal 106 to the satellite 102 to the gateway 104 to internet 120. Server 122 may be a video server.

The terminal 106 may be connected to a user device 130 via LAN 136. Terminal 106 includes a SATCOM stack 112 including a prioritization module 116. Gateway 104 includes schedular 119 and a SATCOM stack 117 including a prioritization module 118. The SATCOM stack 112 requests bandwidth from schedular 119 for the inroute. The SATCOM stack 117 requests bandwidth from schedular 119 for the outroute.

Schedular 119 allows multiple terminals to share the same frequency channel for their respective inroutes. Schedular 119 also ensures that the multiple terminals do not interfere with each other when using their respective inroutes. To achieve this, schedular 119 allocates bandwidth to a terminal as timeslots on the inroute. Allocation is based on allocation requests sent by the terminal 106 to schedular 119 via the SATCOM stack 112. Protocols supported by SATCOM stack 112 may include TCP/IP, a proprietary satellite protocol, or the like.

Allocation of bandwidth on the outroute generally uses codeblocks addressed to one or more terminals. Schedular 119 generally sub-divides the outroute into frames that are further sub-divided into codeblocks where each codeblock contains a particular number of bits.

### Video Streaming Communication Flow

FIG. 2 illustrates an exemplary video streaming process when communicating via a TDMA satellite network.

In satellite networks, several factors contribute to buffering in video streams. The present teachings address these challenges and maximize bandwidth utilization to enhance the quality of video streaming experiences in satellite networks.

A satellite's link capacity is predetermined and fixed. Therefore, the available bandwidth must be distributed fairly among a terminal population, for example, with schedular 119. The bandwidth allocated to terminal 204 depends on the number of terminals competing for bandwidth at any given moment. This dynamic allocation can impact the quality of video streaming, especially during peak usage periods. Moreover, on the outroute, sudden and significant dips in throughput can occur. The dips may result from a sudden surge in instantaneous load, particularly during congested periods of the day. Consequently, the reception time of the next video segment may slow down to the extent that the video player's buffer underruns, leading to buffering issues.

### Mitigation Strategies

Buffering, rebuffering events and poor video quality are mitigated by prioritizing the bandwidth allocated to video streaming traffic using video streaming system 200. Video streaming system 200 may depend on a predicted buffer health of the video player and a current network load and may be used to prioritize bandwidth on either the inroute, the outroute or both. Predicted buffer health is inferred by analyzing metrics associated with the underlying video streaming connections' Internet Protocol packets. While the buffer health may directly predict the number of seconds in the player's buffer, a determination that the buffer health is becoming low is sufficient for the present teachings; extreme granularity is not needed. Video streaming system 200 may predict the buffer health of the video player using various modules, including heuristic algorithms or machine learning models.

Prioritization by video streaming system 200 may be deployed on terminal 204 or gateway 206 singly, or may be split among the two. Exemplary split may use a prioritization module 116 on a terminal or a prioritization module 118 on the gateway. Running a prioritization process at gateway 206 for each terminal 204 streaming video provides a quicker start to a prioritization process. Deployment at gateway 206 may be computationally expensive, however, latency is reduced as terminal 204 does not send the recovery prioritization request 244 over the inroute. Conversely, running it on the terminal distributes computations across each terminal, necessitating prioritization requests to be sent to the gateway 206 from terminal 204.

In some embodiments, a prioritization request may include one or more of a terminal identifier, a priority, a requested level and frequency of prioritized inroute bandwidth, a requested level and frequency of prioritized outroute bandwidth, a traffic type, a channel preference, a video service type, a segment request count, a segment request periodicity or the like. In exemplary embodiments, the prioritization request may include a maintenance prioritization, a recovery prioritization or the like. Upon receiving a prioritization request, for example, a maintenance prioritization, a schedular may allocate a segment request count of inroute bits for the terminal with the segment request periodicity. Upon receiving a prioritization request, for example, a recovery prioritization, a schedular may allocate a count of outroute bits at a recovery priority to the terminal with a periodicity.

In some embodiments, a prioritization response may include one or more of a terminal identifier, a priority, a timeslot start time, a timeslot duration, a traffic type, a transmit power, an ephemeris of a relaying satellite, a request status or the like.

### Operation of Video Streaming on an Inroute in Satellite Networks

In satellite networks, inroute bandwidth allocation may be based on a terminal's queued backlog. With this method, a terminal receives data from user devices, such as video segment requests from video players, and advertises to the gateway how many bytes it needs to transmit. The gateway then grants an allocation to each terminal on the network, considering their individual backlogs, the priority associated with the data, and the inroute capacity. This methodology is subject to an inherent delay. As such, this method may not be suitable for timely and predictable video request transmission due to inherent delays. Prioritization on the inroute seeks to expedite allocation by the gateway by providing a more consistent bandwidth allocation to terminals streaming video, regardless of their advertised backlog. Maintenance prioritization can be applied network-wide on the inroute since video segment requests from the terminal use a small bandwidth.

In a video streaming system 200, a transfer of a series 254 of segment responses 212 may be initiated by sending a segment request 210 from a video client (not shown) on a user device 202 to a server 208 via terminal 204. The operations necessary to transmit an initial segment request are encircled by ellipse 250. As seen in ellipse 250, upon receiving segment request 210, terminal 204 sends a prioritization request 240 to gateway 206 that informs terminal 204 of the requests success/failure status in a prioritization response 242. Subsequently, a timeslot is allotted on the inroute to terminal 204 and terminal 204 forwards the segment request 210 as segment request 210′ to server 208 via gateway 206.

A smooth video streaming experience depends on bandwidth availability on the inroute. When segment request 210 travels to gateway 206 over the inroute, any delays (such time to transmit prioritization request 240, time to receive prioritization response 242, delay to start of allotted timeslot, and delay to transmit the segment request 210′) in getting segment request 210 to server 208 can directly impact subsequent arrivals of segment responses 212′. Increases in inroute load during video streaming can cause dips in raw video segment throughput. This occurs as segment request 210 takes longer to transmit from terminal 204 to gateway 206, resulting in delays in arrivals of segment responses 212′.

In some embodiments, a maintenance prioritization may be provided for a video stream, when a predicted buffer health is deemed sufficient. Maintenance prioritization aims to expedite transmission of segment requests and responses during normal operation.

With a predictive buffer health module, terminal 204 can proactively make a recovery prioritization request to gateway 206. Based on the predicted buffer health of a playback buffer (for example, buffer 134), a recovery prioritization request 244 is sent and a series of prioritized inroute bits and/or outroute bits are communicated between terminal 204 and gateway 206. The recovery prioritization response 246 may arrive at terminal 204 before or after receiving a subsequent segment request 230. Regardless, the allocation of timeslots to transmit a subsequent segment request 230′ is accelerated as the delay between its arrival at terminal 204 and a subsequent transmission to gateway 206 is reduced. The gateway 206 may allocate additional prioritized bandwidth to the terminal 204, at least for some duration, on the outroute to expedite transmission of segment responses 232 pursuant to fulfilling the recovery prioritization request 244. The prioritized inroute and outroute bandwidth allocations continue until terminal 204 receives a configurable number of consecutive video segments.

Buffering may also occur when segment request 210 is dropped on the inroute. This can happen due to various factors such as temporary degradation of a terminal's satellite link (uplink 108 of FIG. 1), especially during adverse weather conditions like rain. When segment request 210 is dropped on the inroute, it necessitates retransmission at a transport layer by the SATCOM stack (for example, SATCOM stack 112 of FIG. 1) of terminal 204. Over a satellite link, these retransmission timeouts can be considerable, often in the hundreds of milliseconds.

### Operation of Video Streaming on an Outroute in Satellite Networks

While maintenance prioritization may be applied to the outroute, bandwidth allocation decisions are made by or near the gateway and do not suffer from inherent latencies incurred in the terminal's bandwidth allocation process on the inroute. However, outroute prioritization can be useful in accelerating the transmission of segment responses from a server to the target terminal when the buffer health has become critically low during recovery prioritization.

In response to segment request 210′, server 208 sends to gateway 206 a series of segment responses 212 on the outroute. The gateway 206 allocates bandwidth on the outroute upon receiving a first segment response of the segment responses 212. As, typically the schedular is disposed in or proximate to gateway 206, there is minimal delay in receiving a response to a bandwidth allocation on the outroute. Upon receiving the allocation, gateway 206 forwards the segment responses 212′ to user device 202 via terminal 204. In some embodiments, gateway 206 may begin the allocation upon forwarding the segment request 210′. Increases in outroute load during video streaming can cause dips in raw video segment throughput. This occurs as the series of segment responses 212′ take longer to transmit from gateway 206 to terminal 204 resulting in delays in arrivals of the segment responses 212′.

The user device 202 receives and writes the segments of the segment responses 212 in a playback buffer, for example, buffer 134 of FIG. 1. The length of data transferred in segment responses 212 is less than or equal to the size of the playback buffer. The sending of segment request 210 from user device 202 and sending of segment responses 212 in response thereto is repeated until the video is exhausted or the video client stops sending segment request 210. Video streaming system 200 may be executed as an ABR flow using standard protocols, such as, Internet Protocol (IP), UDP, TCP or the like.

### Types of Prioritizations

In some embodiments, a recovery prioritization prioritizes bandwidth for a short period of time to prevent buffering. Recovery prioritization may be triggered when the predicted buffer health of the video player becomes critically low. Recovery prioritization may not prevent all buffering across all video streaming services. Rather, recovery prioritization may sustain playback on a video stream playing well and which suffers a low buffer health due to some transitory network event. Recovery prioritization may conclude after the terminal receives a configurable number of consecutive video segments. In some embodiments, the number of recovery prioritization occurrences is limited both per terminal and network-wide within defined periods, based on network load.

### Prioritization Configurability

The boost in bandwidth for video streaming prioritization may be defined as either a raw amount of additional throughput or a relative scheduling factor. These boosts may be configured separately for the inroute and outroute. The separate configurations may account for their distinct capacities and loading patterns, the differing characteristics of video segment requests and responses, and different load capacities on the inroute and outroute. In some embodiments, the amount of additional bandwidth provided may be based on a current network load to avoid negatively impacting other terminals.

Additionally, bandwidth prioritization may be specified per-video streaming service to account for varying streaming protocols, ABR algorithms, and service-specific factors affecting bandwidth requirements. For example, one service may have smaller sized requests and thus require less inroute bandwidth to transmit quickly. Another service may react more slowly to throughput variations, and so a higher recovery outroute prioritization boost may be specified without having the ABR algorithms select a higher bitrate video with higher bandwidth demands.

In some embodiments different thresholds may be used for different video streaming services such as YouTube, Netflix, Sling or the like. This allows for the present teachings to be applied to video streaming protocols as they evolve. Different bandwidth prioritization values (such as the boost in bandwidth and packet priority) may be used for different levels of a network load. For example, prioritization values may be specified at a high network load (such as, 100%≤Utilization≤90%), a medium network load (89%≤Utilization≤50%), and a light network load (Utilization≤49%). The prioritization values may also be different for inroutes and outroutes, gateways and a terminal population, and per terminal.

### Buffer Health Prediction and Recovery Prioritization in Satellite Networks

When the buffer health prioritization is deployed at terminal 204, terminal 204 sends a recovery prioritization request 244 to gateway 206 in advance of the video player's playback buffer becoming empty. This ensures the terminal has sufficient time to receive the prioritized bandwidth and subsequent video segments.

When the buffer health prioritization is deployed at gateway 206, gateway 206 initiates the recovery prioritization process by allocating recovery prioritization response 246 to terminal 204 in advance of the video player's playback buffer becoming empty to ensure the terminal has sufficient time to receive the prioritized bandwidth and subsequent video segments. The gateway also allocates additional prioritized bandwidth to the terminal on the outroute to expedited transmission of segment responses 232′.

### Recovery Prioritization Request Timing:

There is a delicate balance between sending the recovery prioritization request too soon and waiting too long. When sent too soon, the extra prioritized bandwidth may be wasted if the next series of video segments would have been received without prioritization before the playback buffer becomes empty. When sent too late, buffering might occur before the prioritization process speeds up the delivery of the subsequent series of video segments. The predicted timing of sending the recovery prioritization attempts to avoid either scenario.

In a best-case scenario, the video client receives the next video segment before its playback buffer reaches a small threshold t_{c} (illustrated as timestamp 220). This threshold t_{c} defines the cutoff point between maintenance prioritization and recovery prioritization. If the buffer health predicted is bh and the time it will take the video client to receive a first segment of a series of video segments with prioritization is t (timestamp 224), then the terminal should send the recovery prioritization request at a timestamp 222, once it detects bh≤t_{c}+t.

In some embodiments, a terminal can forego initiating a recovery prioritization for the initial configurable tᵢ seconds (timestamp 226) of the video startup as the video client builds its playback buffer.

The reception time t for the next video segment depends on one or more of the following factors:
Whether a pending video segment request has already been sent.
How much of an in-progress segment transfer has already been received.
The total size of the segment.
The inroute throughput from the terminal to gateway.
The internet throughput from the video server to gateway.

The outroute throughput from the gateway to terminal.

The reception time may be t=t_{req}_{_{tg}}+t_{req}_{_{gv}}+tᵣₑₛₚ_{_{vg}}+tᵣₑₛₚ_{_{gt}}, where
(t_{req}_{_{tg}}) is the time to send a segment request from the terminal to the gateway
(t_{req}_{_{gv}}) is the time to send a segment request from the gateway to the server
(tᵣₑₛₚ_{_{vg}}) is the time to send a segment response from the server to the gateway
(tᵣₑₛₚ_{_{gt}}) is the time to send a segment response from the gateway to the terminal

This calculation of reception time t assumes that the travel time over a Local Area Network (LAN) between the terminal and the user device is near zero. Furthermore, assume the terminal can transmit the recovery prioritization request without requesting bandwidth from the gateway using an unallocated channel access method (for example, slotted Aloha, SCMA). Lastly, assume the prioritization requests and subsequent segment requests are not dropped on the inroute.

An upper bound for reception time t may be calculated based on component values that may be estimated or measured. The component values are defined as:
cₛ: The latency between the terminal and gateway over the satellite link (constant, low variation).
cᵥ: The latency between the gateway and the video server over the Internet (dynamic, estimated by the gateway using round-trip times of TCP acknowledgments).
rᵢ: Inroute throughput without prioritization (estimated using a moving average of recent allocation rates).
rᵢ′: Inroute throughput with prioritization (derived from rᵢ by applying throughput boost c or allocation factor).
rₒ: Outroute throughput without prioritization (similarly estimated as inroute throughput).
rₒ′: Outroute throughput with prioritization (similarly estimated as prioritized inroute throughput).
rᵥ: Throughput from the video server to the gateway over the Internet (similarly estimated as inroute and outroute throughputs).
s₁: Size of the video segment request (consistent for a particular streaming service and can be estimated as the average or maximum size of recent requests).
s₂: Size of the video segment (widely variable, an upper-bound estimate can be obtained by taking the maximum of all of the previously received video segment sizes).
   Case #1: Upper-Bound Estimate of t when Pending Segment Request not Yet Sent to the Gateway.

$${t}_{{req}_{tg}} = 2 \cdot {c}_{s} + \frac{{s}_{1}}{{r}_{i}^{′}} + {c}_{s} ,$$

represents the time for the recovery prioritization request to reach the gateway, the time for the terminal to receive prioritized bandwidth over the satellite link, and the time to send the segment request over the satellite link with prioritized bandwidth. This is an upper-bound estimate since the terminal might already be receiving non-prioritized inroute bandwidth.

t_{req}_{_{gv}}=cᵥ, represents the time to send the segment request from the gateway to the video server over the Internet (throughput not considered due to the negligible size of segment requests).

$${t}_{{resp}_{vg}} = \frac{{s}_{2}}{{r}_{v}} + {c}_{v} ,$$

represents the time for the video server to send the segment to the gateway over the Internet.

$${t}_{{resp}_{gt}} = \frac{{s}_{2}}{{r}_{o}^{′}} + {c}_{s} ,$$

represents the time for the gateway to send the segment to the terminal over the satellite link with prioritized bandwidth.
Case #2: Upper-Bound Estimate of t when Segment Request Sent to Gateway to Milliseconds Ago, No Responses Yet Received by the Terminal.
t_{req}_{_{tg}}=0, as the segment request was already sent out, this is 0.
t_{req}_{_{gv}}=max (0, cₛ+cᵥ−t₀), represents the time for the segment request to travel to the gateway over the satellite link and from the gateway to the video server over the Internet, subtracting the elapsed time t₀.

$${t}_{{resp}_{vg}} = \frac{{s}_{2}}{{r}_{v}} + {c}_{v} ,$$

represents the time for the video server to send the segment to the gateway over the Internet. Since the terminal has no knowledge of how much of the segment has been received by the gateway, it can assume none of it has been received to obtain an upper-bound estimate.

$${t}_{{resp}_{gt}} = {c}_{s} + \frac{{s}_{2}}{{r}_{o}^{′}} + {c}_{s} ,$$

request to reach the gateway over the satellite link, plus the time for the gateway to send the segment to the terminal over the satellite link with prioritized bandwidth. This is an upper-bound estimate since the terminal will likely already be receiving non-prioritized outroute bandwidth.
Case #3: Segment request was sent to the gateway; some responses received by the terminal totaling size sₚ

t_{req}_{_{tg}}=0, t_{req}_{_{gv}}=0, as the terminal has already received some responses for the current segment request, the segment request must have already reached the gateway and video server.

$${t}_{{resp}_{vg}} = \frac{{s}_{2} - {s}_{p}}{{r}_{v}} + {c}_{v} ,$$

represents the time it takes the video server to send the remainder of the segment to the gateway over the Internet. Note, it is likely the gateway has received more than sₚ bytes of the video segment by the time the terminal is performing this estimate. However, the terminal has no knowledge of how many additional bytes of the segment have been received. An upper-bound estimate is obtained by assuming only sₚ have been received.

$${t}_{{resp}_{gt}} = {c}_{s} + \frac{{s}_{2} - {s}_{p}}{{r}_{o}^{′}} + {c}_{s} ,$$

represents the time it takes for the recovery prioritization request to reach the gateway over the satellite link, plus the time it takes the gateway to send the remainder of the segment to the terminal with the prioritized bandwidth. Note, this is an upper-bound estimate since the terminal will already be receiving non-prioritized outroute bandwidth.

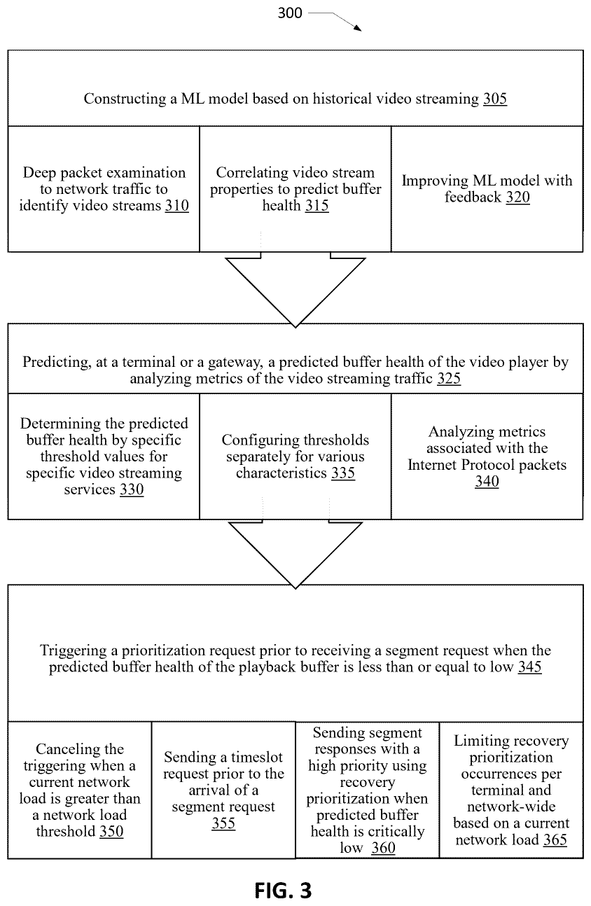

FIG. 3 is a flowchart of an example method for selectively prioritizing data packets of video streaming traffic according to various embodiments.

A method 300 for selectively prioritizing data packets of video streaming traffic is disclosed. Method 300 may include operation 305 for constructing a ML model based on historical video streaming metrics. Method 300 may include operation 310 for performing a deep packet examination network traffic to identify video streams. Method 300 may include operation 315 for correlating video stream properties to predict buffer health. Method 300 may include operation 320 for improving the ML model with feedback.

Method 300 may include operation 325 for predicting, at a terminal or a gateway, a predicted buffer health of the video player by analyzing metrics of the video streaming traffic. The buffer health of the video player can be predicted using various mechanisms, including heuristic algorithms or machine learning models. While the predicted buffer health may directly predict the number of seconds in the player's buffer, the primary goal is to predict when the buffer health is becoming low, rather than achieving extreme granularity. This prediction method may run either on the terminal or the gateway.

Method 300 may include operation 330 for prioritizing the video streaming traffic based on the predicted buffer health of the video player. Different bandwidth prioritization values (such as the boost in bandwidth and packet priority) may be used for different levels of a network load. Different bandwidth prioritization values may be specified based on a route load. Bandwidth prioritization values may be different for inroutes and outroutes. Bandwidth prioritization values may be specified for a high load (such as, 100%≤Utilization≤90%), a medium load (89%≤Utilization≤50%), and a light load (Utilization≤49%). In some embodiments, different prioritization values may be used for different video streaming services associated with video streaming traffic. Exemplary video streaming include YouTube, Netflix, Sling, or the like. Route and video streaming service specific bandwidth prioritization values allow for the present teachings to be applied to video streaming services/protocols as they evolve. Additionally, prioritization values may be specified per-video streaming service to account for varying streaming protocols, ABR algorithms, and service-specific factors affecting bandwidth requirements.

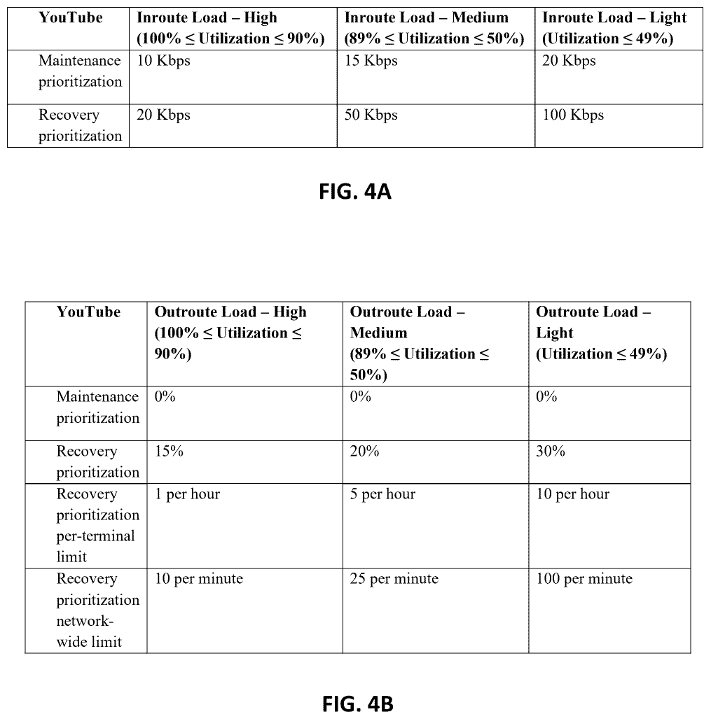

FIG. 4A illustrates exemplary bandwidth prioritization values for an inroute for a specific video streaming service.

FIG. 4B illustrates exemplary bandwidth prioritization values for an outroute for a specific video streaming service.

Method 300 may include operation 335 for configuring prioritization values separately for various characteristics. The prioritization values may be configured separately for the inroute and outroute. The separate configurations may account for their distinct capacities and loading patterns, and the differing characteristics of video segment requests and responses. The boost in bandwidth for video streaming prioritization may be defined as either a raw amount of additional throughput or a relative scheduling factor. The prioritization values may also be different for gateways and a terminal population, and per terminal.

Method 300 may include operation 340 for analyzing metrics associated with the internet protocol packets. The buffer health of the video player can be predicted using various mechanisms, including heuristic algorithms or machine learning models. These mechanisms analyze metrics associated with the underlying video streaming connections' Internet Protocol packets.

Method 300 may include operation 345 for triggering a recovery prioritization request when the predicted buffer health of the playback buffer is less than or equal to low. This prioritization request can be made either on the terminal or the gateway. The prioritization request is used to prioritize bandwidth on either the inroute, the outroute, or both. This is essential for mitigating buffering, rebuffering events, and poor video quality by allocating the necessary bandwidth to video streaming traffic. The predicted buffer health is a key metric in this process, as it helps determine when the buffer health is becoming low and the video is soon about to potentially buffer. The prioritization method includes a maintenance prioritization for normal operation of the video player and a recovery prioritization when the predicted buffer health of the video player is low. Maintenance prioritization aims to expedite the transmission of segment requests and responses during normal operation. Maintenance prioritization can be applied network-wide on the inroute since video segment requests from the terminal use a small bandwidth. Recovery prioritization, on the other hand, prioritizes both inroute and outroute bandwidth, more substantially, for a shorter period to prevent buffering.

Method 300 may include operation 350 for canceling the prioritization when a current network load is greater than a network load threshold. This is done to avoid prioritization under high network load conditions.

Method 300 may include operation 360 for prioritizing segment requests from a terminal to a gateway and segment responses from a gateway to a terminal using recovery prioritization when the predicted buffer health is critically low. This helps sustain playback on a video stream playing well and which suffers a low buffer health due to some transitory network event. The prioritization mechanism includes continuously allocating some amount of inroute and outroute bandwidth at some periodic frequency according to the configuration. The segment requests and segment responses may also be sent with a different priority than normal traffic according to the configuration. Recovery prioritization may conclude after the terminal receives a configurable number of consecutive video segments. The number of recovery prioritization occurrences may be limited both per terminal and network-wide within defined periods, based on network load.

Method 300 may include operation 365 for limiting recovery prioritization occurrences per terminal and network-wide based on a current network load. The limiting may be within defined periods. This is done to control the frequency of recovery prioritization and ensure that it does not negatively impact other terminals.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A method for selectively prioritizing data packets of video streaming traffic, the method comprising:
predicting, at a terminal or a gateway, a predicted buffer health of a playback buffer by analyzing metrics of the video streaming traffic; and
triggering a prioritization request to fill the playback buffer wherein the prioritization request comprises a maintenance prioritization when the predicted buffer health of the playback buffer is greater than low,
wherein the playback buffer is disposed on a device distinct from the gateway or the terminal.

2. The method of claim 1, wherein the video streaming traffic comprises Internet Protocol packets and the predicting comprises analyzing metrics associated with the Internet Protocol packets using a deep packet inspector.

3. The method of claim 1, further comprising canceling the triggering when a current network load is greater than a network load threshold.

4. The method of claim 1, wherein the video streaming traffic is associated with a video streaming service and the predicted buffer health is determined to be low based on threshold values associated with the video streaming service.

5. The method of claim 1, wherein the predicted buffer health is based on bandwidth prioritization values configured separately for combinations of a route, a route type, a route load threshold, and a video streaming service, and the route type comprises one or more of an inroute or an outroute.

6. The method of claim 1, wherein the triggering comprises allocating a count of bits on an inroute from the terminal to the gateway with a periodicity and the count is greater than 1.

7. The method of claim 6, wherein at least one of the count of bits on the inroute is allocated with a priority greater than normal.

8. The method of claim 1, wherein the triggering comprises allocating a count of bits on an outroute from the gateway to the terminal with a periodicity, and wherein the count is greater than 1.

9. The method of claim 8, wherein the prioritization request comprises a recovery prioritization and wherein at least one of the count of bits is allocated with a priority greater than normal.

10. The method of claim 1, wherein the prioritization request comprises a maintenance prioritization for a normal operation of filling the playback buffer and a recovery prioritization when the predicted buffer health of the playback buffer is less than or equal to low.

11. The method of claim 10, wherein the recovery prioritization is limited in occurrences per terminal and limited in occurrences network-wide based on a current network load within a defined period.

12. A system to selectively prioritize data packets of video streaming traffic of a playback buffer, the system comprising:
a processor; and
a memory storing instructions that, when executed by the processor, cause the system to:
predict, at a terminal or a gateway, a predicted buffer health of a playback buffer by analyzing metrics of the video streaming traffic; and
trigger a prioritization request to fill the playback buffer wherein the prioritization request comprises a maintenance prioritization when the predicted buffer health of the playback buffer is greater than low,
wherein the playback buffer is disposed on a device distinct from the gateway or the terminal.

13. The system of claim 12, wherein the video streaming traffic comprises Internet Protocol packets and the instructions analyze metrics associated with the Internet Protocol packets using a deep packet inspector.

14. The system of claim 12, wherein the video streaming traffic is associated with a video streaming service and the predicted buffer health is determined to be low based on threshold values associated with the video streaming service.

15. The system of claim 12, wherein the predicted buffer health is based on bandwidth prioritization values configured separately for combinations of a route, a route type, a route load threshold, and a video streaming service, and the route type comprises one or more of an inroute or an outroute.

16. The system of claim 12, wherein the instructions allocate a count of bits on an inroute from the terminal to the gateway with a periodicity and the count is greater than 1.

17. The system of claim 12, wherein the instructions allocate a count of bits on an outroute from the gateway to the terminal with a periodicity, and wherein the count is greater than 1.

18. The system of claim 12, wherein the prioritization request comprises a maintenance prioritization for a normal operation of filling the playback buffer and a recovery prioritization when the predicted buffer health of the playback buffer is less than or equal to low.

19. The system of claim 18, wherein the recovery prioritization is limited in occurrences per terminal and limited in occurrences network-wide based on a current network load within a defined period.

20. A non-transitory processor-readable storage medium having stored therein program code of one or more software programs for selectively prioritizing data packets of video streaming traffic, wherein the program code when executed by at least one processing device causes at least one processing device to perform:
predicting, at a terminal or a gateway, a predicted buffer health of a playback buffer by analyzing metrics of the video streaming traffic; and
triggering a prioritization request to fill the playback buffer wherein the prioritization request comprises a maintenance prioritization when the predicted buffer health of the playback buffer is greater than low,
wherein the playback buffer is disposed on a device distinct from the gateway or the terminal.
